(19) United States
(12) Patent Application Publication
(10) Pub. No.: US 2009/0098524 A1
(43) Pub. Date: Apr. 16, 2009

(54) Internet-based Pedagogical and Andragogical Method and System Using Virtual Reality

(76) Inventor: Brien C. Walton, Bethesda, MD (US)

Correspondence Address: Brien C. Walton, 5500 Bradley Boulevard, Bethesda, MD, 20814-1004, US

(21) Appl. No.: 12/240,470

(22) Filed: Sep. 29, 2008

Related U.S. Application Data
(60) Provisional application No. 60/975,593, filed on Sep. 27, 2007.

(51) Int. Cl. G09B 3/00

(52) U.S. Cl. 434/350

(57) ABSTRACT

An interactive system and methods of instruction and administration using virtual reality or other technology to create a simulated learning environment of multi-dimensional graphical representations of participants, who interact through individual and collaborative, task-based exercises, via an artificial intelligence engine utilizing an input/output arrangement over a network such as the Internet. This system facilitates synchronous or asynchronous, individual or group instruction to anyone with access to the Internet, measures the efficacy and retention of instruction, and automates faculty processes of grading, scheduled postings, feedback, generating quantitative and qualitative reports, generating adaptive lessons that adjust to participant input, and the like, with exportable and importable academic, financial, and demographic data to address the needs of faculty, administrative staff, including registrars, admissions officers, and counselors, as well as other interested parties such as parents and guardians.

### CROSS-REFERENCE TO RELATED APPLICATIONS

This application claims the benefit of provisional patent application Ser. No. 60/975,593, filed Sep. 27, 2007.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates generally to the field of education, and more specifically to a method for the use of virtual reality, or animated graphics, to facilitate learning through increased interaction by children or adults, and a system to facilitate instruction, academic administration, and education community interaction in a virtual reality environment.

2. Description of Prior Art

Virtual reality has been used for entertainment purposes for many years but has been minimally utilized for educational purposes. There are essentially five key reasons why virtual reality use in education has not made sufficient progress:
a. Online Teaching Methodology—many educators are still unfamiliar with best practices in online teaching methodology, which is the starting point for understanding how to provide instruction in a virtual reality environment. There are also differences between teaching children (pedagogy) and teaching adults (andragogy) that directly influence the efficacy of instruction. Much of the prior art does not incorporate best practices in online teaching,
b. Online Course Management Systems—most course management systems are designed for asynchronous interaction, where each learner and the educator will post at different times during the day, at their own convenience. This type of interaction can lead learners to feel disconnected from their classmates and the educator due to the asynchronous nature of online interaction, like threaded discussion where the audience is not online at the same time. Another common, but confusing and disorganized scenario is often created by a synchronous group chat, where several people all type at the same time trying to get their point across. In addition, most learners need something beyond an occasional response from the educator, or “canned” discussion questions. Even positive feedback on assignments can only sustain the learner's attention for just a few login sessions, and simply reading text on a page is usually not enough to sustain long-term attentiveness, since the visual stimulation is minimal. Much of the prior art does not address the needs of the learner in how substantive content is received and processed by the learner,
c. Entertainment vs. Education—an adequate virtual reality environment designed specifically for education and focuses the attention of the audience on specific learning objectives, is not commercially available. Schools that try to “force fit” their content into a social networking or video game environment, both of which have different objectives from education, often find that their learners are quickly frustrated and overwhelmed. Efforts to adapt existing commercial environments can produce disappointing results for educators, due to non-content related distractions that can dominate the viewable area and prevent retention of the substantive material. For example, if the virtual reality environment is a simulated lecture hall, but the characters (“avatars”) representing members of the audience have surrealistic attributes, like the ability to fly, or appear as cartoon animals, each time a new member of the audience enters the lecture hall is likely to draw attention away from the instruction. Much of the prior art does not attempt to engage learners in the academic context,
d. Game vs. Instruction—most educators still associate virtual reality with the video game industry, which can prevent them from seeing how the software platform can be used to enhance learner collaborative learning and increase retention of the substantive content. Much of the prior art relates to the entertainment value of virtual reality, with little attention to the academic context,
e. Curriculum Adjustment—many educators are not aware that providing instruction in an online environment requires adjustments to curriculum, as well as teaching style, which has led to very high attrition rates in many online education programs. Much of the prior art does not address the curriculum adjustments required in converting or adapting curriculum from a face-to-face environment to the online environment,
f. Academic Administration—although course management systems are designed to help educators provide instruction to learners, the needs of administrators and administrative staff are often ignored. Administrators, admissions staff, and counselors play integral and important roles in supporting educators and learners, and having easily accessible academic and social progress reports, as well as the ability to interact with academic staff most familiar with the learner is essential to providing a coordinated and comprehensive strategy to maximize the learner's potential. Much of the prior art does not integrate key academic administrative staff in order to provide support and collaboration between educators and other academic personnel familiar with the learner.

### BRIEF SUMMARY OF THE INVENTION

Although other methods of online instruction exist, the method that follows is preferable over previous methods of instruction in a virtual reality, or animated graphics environment, because it encompasses the use of virtual reality to teach an entire class, or to supplement face-to-face instruction using a Real-Life Virtual Education Immersion System (R.V.E.I.S.). The method presented in this invention addresses areas often overlooked by educators and administrators by specifically addressing the key distinctions between learning in a physical classroom environment and learning online. The method presented by this invention incorporates best practices in online education, as well as delivering educational content with curriculum adjustments in consideration of the individual learning styles of the audience, which enhance learner satisfaction with the online education process in both asynchronous and synchronous delivery formats. The method presented in this invention is also designed to help education providers increase substantive interaction amongst learners and educators, in addition to increasing an academic institution's enrollment retention rates. The preferred embodiment of the method presented in this invention is an educational context, with the focus on enhancing instruction, although it is to be understood that other embodiments of the system that incorporate the providing of instruction, in various forms, may be utilized without departure from the scope of the invention.

The system presented in this invention is preferable over previous systems because the virtual reality classroom and information access interface that embodies the method presented in this invention can be produced using open source or proprietary database and word processing software, and accessed by standard, open source or proprietary software that supports and exports in software code appropriate for creating virtual reality images viewable in a standard Web browser. The integration of the virtual reality classroom environment, information access interface, and the method presented in this invention, is referred to as a “Real-Life Virtual Education Immersion System” (R.V.E.I.S.).

R.V.E.I.S. embodies the method presented by this invention system presented in this invention also provides an integrated environment that compliments the instruction and facilitates interaction between learners, educators, administrators, academic support staff, and other parties interested in the learner's academic and social development. For example, staff in the Admissions office can access the system to view and generate reports of test scores for an individual learner or an entire class, and compile statistical data to present to prospective learners or accrediting agencies. Parents can also access the system to view the academic progress of their child in prior weeks, years, and even in real-time (as an observer) as their child completes a task-based assessment. The educator can also facilitate an interactive discussion with learners, in a different section of the environment, and each of these scenarios with administrators, parents, learners, and educators, can occur synchronously or asynchronously on the same system.

With regard to the terms used in this specification, the term “invention” includes “inventions”, which is the plural of “invention”. By the use of the term “invention”, the Applicant does not in any way admit that the present application does not include more than one patentable, non-obvious and distinct invention, and the Applicant asserts that the present application may include more than one patentable, non-obvious and distinct invention, and in the event that there is more than one invention, that these inventions may be patentable, non-obvious and distinct, one with respect to the other inventions.

### BRIEF DESCRIPTION OF THE SEVERAL VIEWS OF THE DRAWING

FIG. 1 is a diagram illustrating a plurality of networked connections by which R.V.E.I.S. facilitates data interchange between its database and computer users;

FIG. 2 is a diagram of certain functional processes provided by R.V.E.I.S., dependent upon type of computer user shown in FIG. 1;

FIG. 3 is a tree diagram illustrating how the method presented in the invention can be implemented by an educator;

FIG. 4 is a diagram of a sample lesson plan for a higher education course with business law content that illustrates the application of the method resulted in this invention to the course structure;

FIG. 5 illustrates the preferred layout of an R.V.E.I.S. home page;

FIG. 6 illustrates the preferred layout of a sample “Presentations & Online Resources” R.V.E.I.S. user interface page; and

FIG. 7 provides an example of how the virtual reality environment can appear from the computer user's perspective during an assessment.

### DETAILED DESCRIPTION OF THE INVENTION

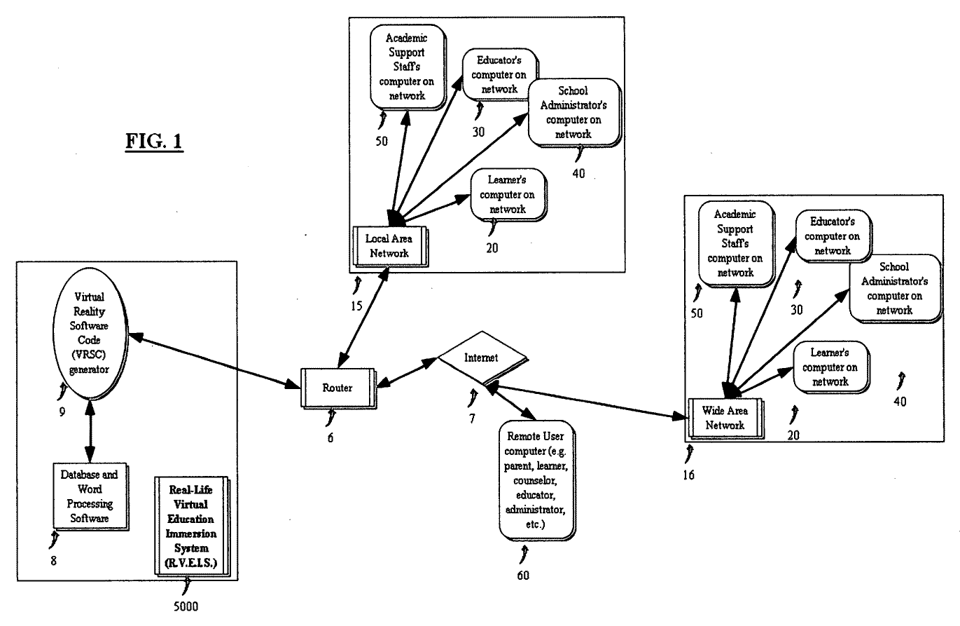

In the following detailed description of the preferred embodiment, we refer first to FIG. 1, but it is to be understood that other embodiments of the system, and pathway configurations of the system, may be utilized without departing from the scope of the present invention.

In FIG. 1, a virtual reality software code (VRSC) generator (e.g. virtual reality modeling language) 9 and a related database 8 are integrated to form a Real-Life Virtual Immersion System (R.V.E.I.S.) 5000. R.V.E.I.S. provides instruction and academic administrative services in a virtual reality environment to a plurality of networked computer users connected via routers 6 on a local area network 15, or via the Internet 7 to a Wide Area Network to a Wide Area Network implemented in a client-server topolology 16 of computer users, or individual remote computer users 60. R.V.E.I.S. 5000 generates animated graphical representations of information contained in its related database 8 of course content accounts, which contain the subject matter to be taught (e.g. business law course content account), as well as text-based information, and reports of computer user activity. In the embodiment illustrated in FIG. 1, R.V.E.I.S. 5000 can facilitate data interchange between school administrator user accounts (e.g. principals, deans, or admissions office staff) 40, educator user accounts (e.g. teachers or professors) 30, academic support staff user accounts (e.g. counselors) 50, learner user accounts (e.g. students or a corporate training audience) 20, and parents of learners (or other parties interested in the learner's progress) user accounts 60.

In the preferred embodiment of FIG. 1, different computer users are provided concurrent and sequential access to a networked system with R.V.E.I.S. 5000 as the central component. Depending upon the needs of the computer user, access to data and the virtual reality environments on R.V.E.I.S. 5000 will be provided on demand by software executable on the server system, and will generally include R.V.E.I.S. 5000 and at least two other computer users, usually an educator 30 and learner 20, with the learner 20 having restricted access via user authentication as determined by the educator 30. If R.V.E.I.S. 5000 is used to educate an entire class, then there will be an educator 30 and a plurality of learners 20, each with separate user accounts. If the administration 40 is interested in compiling statistical data from learner 20 test scores, then educators 30, learners 20, and administrators 40 can each have their respective access to data 8 and environments 9 available through R.V.E.I.S. 5000, two separate user accounts. A computer user 60 can access R.V.E.I.S. 5000 using a standard Web browser, and navigation of the menus and environment can be accomplished by keyboard, mouse, motion controllers (e.g. joystick) or if the virtual reality environment is voice-enabled—navigation by voice commands.

The type of network in the preferred embodiment can be either a closed (e.g. dedicated) network 15, or an open network (e.g. Internet) 7, with data exchanged between R.V.E.I.S. 5000 and computer users 60 on the network 7 via a router 6 connected directly to the R.V.E.I.S. 5000 interface through standard electronic data transmission languages and protocols appropriate for the Internet 7. R.V.E.I.S. 5000 manages the receipt of data, processing of data, handling of data, manipulation of data, extraction of data, integration of data, sorting of data, and transmission of data, to and from computer user accounts 60 connected to the system via a router 6 as the central communication medium. The database 8 and VRSC generator 9 are not required to be in the same physical location, and can be maintained separately by technical support staff who can maintain the computers upon which the database 8 and VRSC generator 9 are installed.

In the preferred embodiment, the database 8 and VRSC generator 9 are installed on a single computer, but it is understood that other embodiments may be utilized when other factors are present, without departure from the scope of the invention. For example, another embodiment could be a scenario where network or information security is a concern. In that scenario, the database 9 can be stored in one location on one computer, and the VRSC generator 9 can be stored remotely on another computer in another location, with information and data exchanged via the Internet 7.

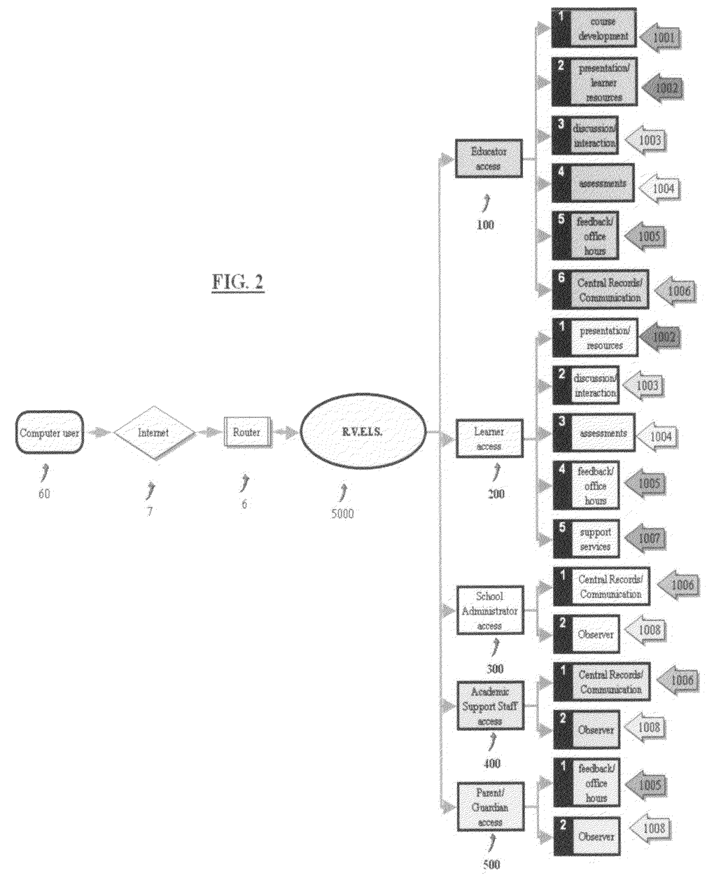

In FIG. 2, R.V.E.I.S. 5000 operates as a “processing center” that receives input from a computer user 60 corresponding to their level of access, e.g. educator 100, learner 200, school administrator 300, academic support staff 400, or other party interested in the learner's 20 academic and social development, like a parent or guardian 500. Once the computer user 60 logs into R.V.E.I.S. 5000 using a unique ID and password, they are provided a menu page corresponding to their level of access, and the opportunity to choose among several options.

Educator access 100 provides: 1) the option to select from the course development tools content account 1001, which allow the educator 30 to adjust and modify how R.V.E.I.S. 5000 appears and functions; 2) the option to select the presentation and learner resources content account 1002, which can consist of audio, video, text, or virtual reality lectures, slideshow presentations, and hyperlinks, to resources accessible on a local network 15, wide area network 16, or the Internet 7; 3) the option to select the discussion and interaction content account 1003, which allows the educator 30 to interact with learners 20 in a virtual reality environment that simulates a classroom, lecture hall, or other appropriate educational context in the preferred embodiment, or in other embodiments, allow educator 30 to interact via audio only, text only, a combination of audio and text, or video conferencing; 4) the option to select the assessments content account 1004, where the educator 30 can create tests and academic performance measures in the virtual reality environment in the preferred embodiment, as well as text only, or combined audio and text assessments in alternative embodiments, any of which can be manually graded by the educator 30, or automatically graded by R.V.E.I.S. 5000 using software executable by the computer server system using preprogrammed grading rubrics contained in the database 8, the educator 30 can also monitor and evaluate learners' 20 progress during and after an assessment, and the educator 30 can make grades visible to learners 30, or other members of the education community via authenticated access to the learner user's assessments content account 1004; 5) the option to select the feedback and office hours content account 1005, which is an area where asynchronous feedback can be provided to learners 20 by text, audio, video, or synchronously by “virtual office hours”, where the educator 30 provides the learner 20 feedback and insight in a virtual reality office or other educationally appropriate setting; and 6) the option to select the central records and communication content account 1006, which allows the educator 30 to view and share learner 20 information, assessment results, or course statistical data, and communicate via text, audio, or video messaging, as well as a virtual reality conference, with any or all members of the education community, such as the learner 20, administrators 40, academic support staff 50, or the learner's parent or guardian 60.

Learner access 200 provides: 1) the option to select the presentation and resources content account 1002 in view only mode; 2) the option to select the discussion and interaction content account 1003 (as described previously); 3) the option to select the assessments content account 1004, where the learner 20 can interact with assessments and complete them, but cannot create a new assessment; 4) the option to select the feedback and office hours content account 1005, to interact and communicate one-on-one with the educator 30 and where the learner 20 can always see their current grade and all assessment scores for the course; and 5) the option to select the support services content account 1007, where the learner 20 can obtain technical support, academic support staff consultation, or self learn through software tutorials.

School administrator access 300 provides: 1) the option to select the central records and communication content account 1006 (as described previously); and 2) the option to select Observer 1008 status, which allows the administrator 40—in view only mode—to observe interaction in a class discussion or monitor a learner's progress during an assessment in real time.

Academic support staff access 400 provides: 1) the option to select the central records and communication content account 1006 (as described previously); and 2) the option to select Observer 1008 status (as described previously).

Parent or guardian access 500 provides: 1) the option to select the feedback and office hours content account 1005, to interact and communicate one-on-one with the educator 30 and see their learner's 20 current grade and all assessment scores for the course; and 2) the option to select Observer 1008 status, which allows the parent, guardian, or other party interested in the academic and social development of the learner 20 to monitor—in view only mode—a learner's progress during an assessment in real time.

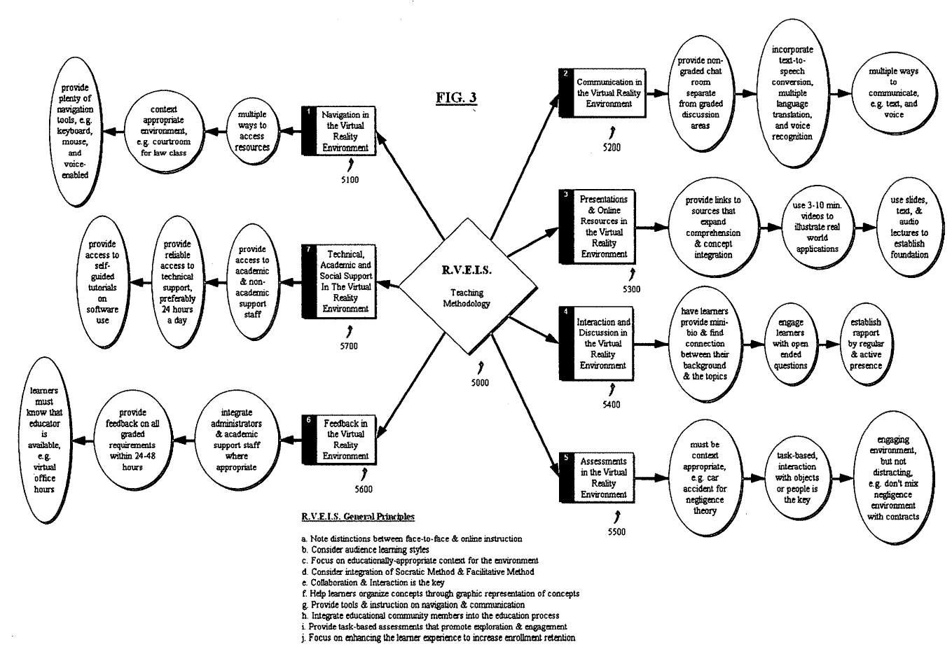

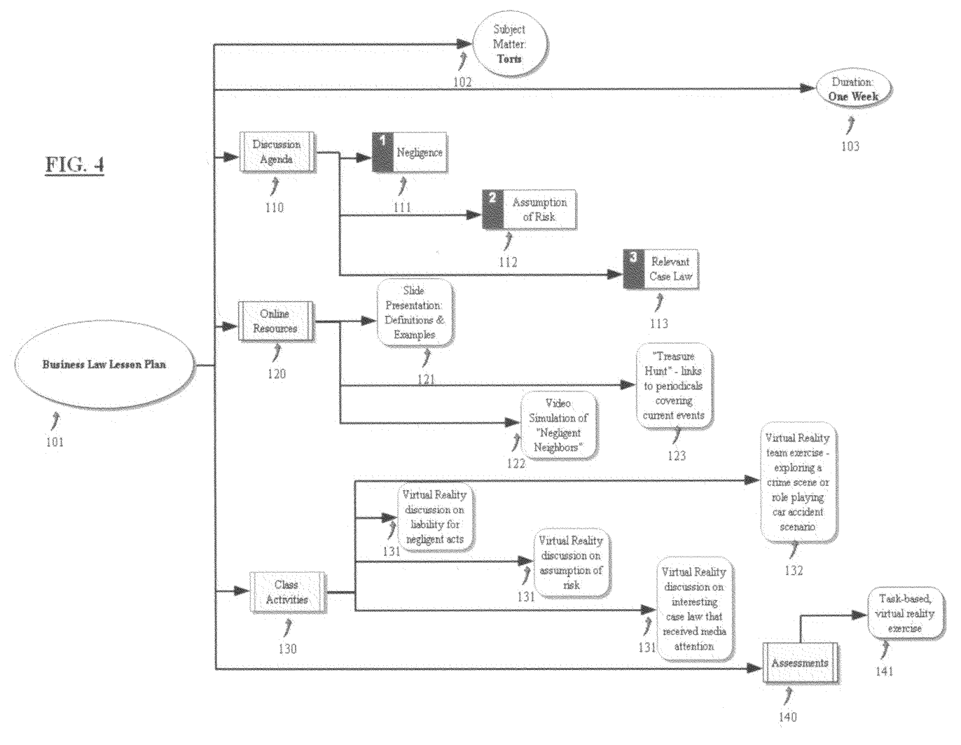

In FIG. 3, the preferred embodiment of the method is illustrated by educational objective, and illustrated by application in FIG. 4. The good news is that academic institutions can improve learner retention and increase overall learner satisfaction through an interactive, virtual reality education experience, by focusing on key distinctions between learning in a face-to-face environment, and distance learning.

Learners 20 respond to mastering new concepts in different ways, for example, some learners are visual learners and learn most effectively through seeing, while some people are auditory learners and learn most effectively by listening. There are also kinesthetic learners, who learn most effectively through motion, touching, or other perceived physical contact. In almost all commercially available software programs designated as “course management systems”, the use of threaded discussion only addresses the needs of visual learners to the limited extent that the learners read text on the page, and sometimes may be able to view a slide presentation, if the educator 30 has made the effort to include one. Using virtual reality however, a learner not only receive a visual experience through the inherent graphical representation of them and objects in the environment 130, but speech capabilities from text-to-speech integration, or voice over integration, can provide an auditory experience as well. With current virtual reality software providing high-resolution images with the realistic textures and the ability to interact with objects and people in the environment with simulated laws of gravity, some learners can also receive a kinesthetic experience.

In order to be effective in educating learners 20 in a distance learning program, the educator 30 should make key distinctions between the Socratic Method used in the face-to-face learning environment and an “Online Facilitative Method”, that is appropriate for a distance learning environment. The key distinction being that the Socratic Method primarily uses direct, educator-to-learner interaction, while the Online Facilitative Method primarily uses collaborative, learner-to-learner interaction and the educator facilitates the flow of ideas and information. An example of the Socratic Method in a face-to-face class is where the educator calls upon the learner to answer a direct question presented only to that learner—“John, what are the elements that establish a contract?” This can make the learner very nervous, and often results in learners trying to sit as far away from the educator as possible, out of fear of being called upon to answer a direct question. In an online class however, the educator would present a broad, open-ended question to the entire class, which has multiple correct answers, so that every learner can more easily answer the question. Even though the answers may differ from one another, each learner could be correct in their response, for example, an appropriate question to begin the process of developing critical thinking skills would be to present the question—“Class, is the sky blue?”

The Online Facilitative Method is inherently “collaborative” and this applies to the virtual reality environment as well. Learners provide their respective insight based upon their individual perspective, and as learners learn how others perceive the same issue, they can then re-evaluate their own views and opinions in order to create a modified or enhanced perspective. This means that learners learn from their classmates by cooperating with each other to solve a problem or complete a task. This also promotes an environment where the learners feel more comfortable expressing their ideas, which can increase their motivation to participate substantively in class discussions. In short, R.V.E.I.S. promotes an integration and modification of the Socratic Method to engage the learner 20 without the undertone of confrontation.

To maximize the learners 20 educational experience on R.V.E.I.S. 5000, educators 30 should provide learners with guidelines and reasonable expectations for interaction 130, e.g. days of participation (3 days a week at 4 p.m., etc.), how to navigate the virtual reality environment (video tutorial 1007 or make a “training class” part of the participation grade, etc.). Also important, is a means of evaluation 140 (should be based upon level of interaction, role-playing exercises [learner as a judge in a courtroom], and mastery of concept activities like the “scale of justice” exercise, etc.).

The key to the R.V.E.I.S. 5000 method is addressing seven key areas in the education process, in the correct order of presentment:
1) Navigation in the Virtual Reality Environment: The key objective for any educator should be to create an environment that is educationally appropriate—facilitates interaction and the academic process. As a result, R.V.E.I.S. 5000 provides “point and click” navigation tools that make it easy for educators 30 and learners 20 to navigate their way through the environment. For example, if a learner wants to place an object on the scales of justice, the learner could move the mouse over the object and right click the mouse to pick it up, then they could right click the correct side of the scale to release the object onto the scale. Course announcements and the course materials can be accessed in a similar manner—the learner can click an object that represents the syllabus, discussion areas, even a digitized version of the textbook and supplemental material.
2) Communication in the Virtual Reality Environment: It is also preferred to establish multiple means of communication to prevent learner frustration. In most existing virtual reality environments, the only option is typing a response in English. In an educational setting, where some learners may not be native English speakers, or have limited typing skills, typing in English often results in a very frustrating experience. The ideal solution is using an environment that integrates voice recognition technology, text-to-speech conversion, multi-language translation, or voice over Internet protocols (VOIP). I have also found that is best to limit the maximum class size to 15 learners in order to maintain control of the flow of ideas—although multiple sections of the same class can be arranged to run concurrently, but separately. By integrating the speech technology, and facilitating small group interaction, greater access to the discussion is created, with the least amount of frustration.
With regard to communication, the preferred embodiment incorporates text and speech capabilities to enable learners to communicate in various ways and to help keep the interaction focused. The educator 30 can establish a separate room in the environment for learners 20 to chat informally (e.g. a Chat Room). Separate from this room, would be the main environment that is primarily used for interaction between the educator 30 and learners 20. By organizing areas of the environment according to the specific tasks to be performed (e.g. educator 30 interaction in one area 131, assessments in another area 140, chat room team exercises in another area 132, and course materials in another area 120, etc.), learners 20 usually become less frustrated. The reason being that they always know where to go to obtain the information required to complete the task assigned. An added benefit to this type of compartmentalization is that educators 30 will not only be able to monitor how many times a learner enters a respective area, but can also use the server data to identify learners 20 that may be falling behind.
3) Presentations & Online Resources in the Virtual Reality Environment: The educator 30 must provide plenty of tools and resources 120 for learners 20 to establish a foundation of understanding of the core concepts, and the means to enhance and build upon that knowledge through resources that examine collateral issues as well as in depth issues. At a minimum, an educator 30 may begin with slide presentations 121 covering basic definitions and simple examples grouped by topic or chapter.
From this starting point, presentations quickly progress to engaging, preferably humorous, video 122 simulations of the concepts, and provide learners 20 a list of hyperlinks to periodicals on the Internet 123, which cover relevant topics and will require the learners to recognize the concepts covered in application. For example, if the learner is searching for articles on negligence and can recognize that someone who causes a car accident due to trying to read their newspaper while driving down a busy street, part of the learning objective has been accomplished.
4) Interaction and Discussion in the Virtual Reality Environment: The paramount objective in online teaching methodology is for the educator to use open-ended questions to engage the learners and allows each learner to share their unique insight, and still be correct, and this will increase learner participation levels. This is also an effective way to help learners feel more connected to the class. The increased participation levels are the result of the learner realizing that they have something to contribute, that their opinion is valued, and the positive reinforcement from the class and the educator encourages them to contribute again, and again. From this starting point, the educator 30 can build a rapport with learners 20 through engaging and responsive interaction 131 that begins prior to the first day of the course. Ideally, the educator 30 would briefly meet with each learner 20 where practicable, in order to provide an overview of the course and answer questions. If learners 20 are not centrally located, this process can be accomplished on R.V.E.I.S. 5000 using the virtual office hour's 1005 feature. The rapport is further strengthened by the educator's 30 active participation in the discussion 131 and efforts to find a way for each learner to make a meaningful contribution without fear of criticism, e.g. providing an open ended question such as “Class, is the sky blue?”.
5) Assessments in the Virtual Reality Environment: Assessments 140 should be task-based, fair and objective, but also engaging and an accurate measure of the learners 20 mastery of the material. By creating the assessments 140 in a virtual reality environment 141 the learner 20 becomes an active participant in the learning and assessment process, engaging multiple senses to accomplish the task, e.g. allocating liability to participants in a scenario, or identifying key distinctions between related concepts by selecting a representative object. Essentially, the biggest challenge with virtual reality in education is creating the “means of evaluation”.
The “means of evaluation” refers to quizzes and homework that learners will complete in the virtual reality environment. For example, a quiz question could be presented to learners and their mastery of the concept measured, is illustrated by the example of the learner witnessing a car accident and having to make a determination of whether the driver was negligent or not negligent. Another example, where virtual reality can be used to illustrate contract formation, is by creating an environment where learner A agrees to pay learner B one dollar, if learner B moves an object from one side of the room to the other. The element of a contract requires that there be: i) an offer by learner A, ii) acceptance by learner B, iii) consideration or the transfer of something of value, and iv) performance of the task that merits the transfer of consideration from learner A to learner B.
From that understanding of the four elements of a contract, the scenario can then be adjusted an almost unlimited ways. For example, learner B may not verbally agree to the offer but performs the task anyway, or learner A makes the offer to learner C, but learner B completes the task before learner C can do so, or learner B moves the wrong object, etc. Each of these variations of the scenario can have an impact on whether a contract was established, and who would be entitled to receive the dollar that was offered. Whatever scenario variation the educator 30 chooses to present to the learner 20, the way the learner 20 answers the question can be a constant. For example, but learner 20 would select an object in the environment that represents whether the contract was established, or not, (e.g. the learner could place an object on the side of the scale labeled “contract was established”, or alternatively, on the side of the scale labeled “contract was not established”.
By creating tasks that are innovative and fun, even difficult and arduous tasks will be welcomed by the learners. Being an active participant not only helps learners internalize and apply the concepts to a “real” situation, but it can simultaneously distract them from the amount of reading they did in preparation for completing the task. In that regard, the increasing popularity of video games and the enjoyment people obtain from being immersed in a virtual environment indicates how enjoyable and educational the environment can be for learners, if designed and developed with the appropriate structure.
Although the examples are in the context of business law curriculum, the same principles can be adapted to apply to other subject matter areas, and it is to be understood that other embodiments of the method may apply to different subject matter, and that application of the method in a different order of implementation may be utilized without departure from the scope of the invention. The method described is designed to help a faculty member determine if the virtual reality environment is appropriate for their course, and if so, help them make the transition from the current standard of “threaded” discussion to the prospective use of “immersion” discussion through virtual reality software. Unfortunately, if the educator is not careful in how they design the environment, it is very easy to create an environment that distracts the learner through over stimulation and the effectiveness of the learning process decreases substantially. This problem usually occurs when using an environment that is not specifically designed for education. For example, in teaching a course on business law, it would not be appropriate to hold the class in a simulated beach setting where there are seagulls flying overhead, boats on the water, and a beach volleyball game underway. An appropriate environment would be the creation of a simulated courtroom, with few extraneous characters moving about the room. By minimizing distractions, and keeping the environment in the educationally appropriate context of the material being covered, the educator can maximize the effectiveness of the virtual reality medium.
6) Feedback in the Virtual Reality Environment: Upon completion of the Assessment 140, feedback should be provided to the learner 20 within 48 hours, preferably within 24 hours whenever possible. This reduces learner 20 anxieties, enhances learner 20 rapport with the educator 30, and provides learner 30 adequate time to prepare for the next graded exercise by incorporating lessons learned. The educator 30 should also be available at least once each week at a predetermined time through the virtual office content account 1005 in order to respond to learner 20 concerns, as well as potential questions from other members of the education community who are interested in a learner's 20 academic and social progress.
7) Technical, Academic and Social Support in the Virtual Reality Environment: Many learners 20 are not computer experts, or an experienced Internet user, or understand how to express themselves appropriately in an online environment. As a result, all learners 20 should be provided access to the support services content account 1007, whether they use them or not. There should be self-guided tutorials on software usage, online etiquette, how to use spelling and grammar checkers, and instruction manuals, if available. In addition, tutoring services and learner counseling can help prevent learners from falling to far behind, or identified the need to provide remedial work for learners who may not have accurately gauged their competency level. There should also be non-academic learner support services (e.g. school counselors) to help secondary school learners through feelings of isolation or peer pressure, and for higher education, helping adult learners cope with the loss of a family member, or financial loss, or simply adjusting to their decision to return to school. Providing this support can help educators 30 keep learners 20 on track to their career and life objectives.

In FIG. 4, the preferred embodiment of an assessment is illustrated with a sample lesson plan 101. The lesson plan is provided for a one-week segment 103 of a higher education course entitled “Business Law”. In a business law course that covers the legal theory of Torts 102, a learner 20 is provided a with a weekly agenda 110 to help them identify key concepts, prepare and organize their approach the material, and recognize the learning outcomes. For example, mastery of theories of negligence 111, mastery of theories of assumption of risk 112, and understanding of relevant case law illustrating those theories 113. The learner 20 is presented online resources 120 to provide a foundation of understanding for the new concepts presented by the educator 30 through lecture slides 121 illustrating definitions and examples of tort applications, brief 3 to 10 minute video 122 simulations or actual footage of persons involved in clear cases of negligent behavior. For example, an intoxicated person decides to mow lawn at 2 a.m., falls asleep on riding mower and plows through neighbor's fence, crashing into a neighbor's above ground pool, causing pool wall to collapse and flooding neighbor's award-winning garden with thousands of gallons of chlorinated water. These passive learning experiences are then combined with an interactive online search exercise (e.g. online treasure hunt) that allows learners to explore the Internet for relevant examples of negligent acts—found relatively easily from a list of educator-provided links 123.

Through this process, the learner's comprehension of the topics have progressed from simply defining key terms, to understanding the theory as it applies to a real world situation, to being able to independently identify and associate applications of the concepts in new an abstract scenarios—which demonstrates a measurable level of applied understanding of the material covered.

Throughout the week, the educator 30 engages learners 20 in class activities 130 that provide the learners 20 with opportunities to integrate the information obtained from the online resources 120 and test their understanding of the concepts. This is accomplished by the learner 20 responding to discussion questions presented by the educator 30, as well as reflecting upon and responding to questions and insights shared by fellow learners 20. In the preferred embodiment, this interaction takes place in a virtual reality environment 131 on at least three separate days during the week to ensure sufficient educator 30 presence. The educator's 30 presence is required to explain and elaborate on key concepts, as well as to facilitate the flow of interaction and accomplish coverage of the three agenda 110 items, e.g. 3 days cover three agenda items. On at least one other day during the week there should be a team exercise 132, where two or more learners perform a task-based exercise involving exploration to locate an item or information in a educationally context appropriate scenario, or a role-playing exercise.

For example, based upon the scenario with the negligent neighbor, the educator 30 elaborates upon the facts to state that the negligent neighbor claims the lawnmower had a defective blade housing that allowed the speed regulator to be severed, which propelled him through the fence and into the pool. This fact could make the lawnmower manufacturer strictly liable for the damage caused under the legal theory that inherently dangerous items can result in strict liability for the manufacture. Based upon these additional facts, two learners could be given the task to explore the virtual scene of the crime and find an object(s) that would indicate the “inherently dangerous” parts of the lawnmower. To ensure interaction however, the defect of part is in it least two pieces and the part serial numbers—which are half on one object and half on another—have to match the manufacturer serial number once put together. Each learner is provided the serial number for a half, and is required to present their teammate's half—not their half—to the virtual chief investigator. As a result, each learner 20 must work together and collaborate with their teammate in order to succeed in the task.

In referring to the numbered agenda 110 items—1 through 3—it should be noted that each number represents a day of the week, for example 3 days per week of Monday, Wednesday, and Friday. On each day, there are scheduled online resources 120 and class activities 130 that lineup below the agenda 110 items and help illustrate orderly progression of the concepts involved in the learning process during the week. The week 103 concludes with an assessment 140 to measure the learner's 30 mastery of the concepts, which in the preferred embodiment would be a virtual reality task-based exercise 141. For example, the learner 20 in the virtual reality environment generated by R.V.E.I.S. could be the witness at the scene of a car accident (acted out by other learners in respective roles in the group assessment).

Alternatively, the learner 20 can view a virtual reality movie for an individual learner assessment, and based upon the learner's understanding of “negligence”, could walk over to a scale of justice in place a representative object, e.g. a coin on the side of the scale that indicates “negligent” or “not negligent”. Alternatively, the learner could identify the respective roles of persons found at the scene of the crime—negligent person, victim, witness, exculpatory evidence, such as a defective piece of machinery, evidence of contributory negligence, such as the victim was reading a newspaper while driving, etc.

Through this type of assessment the learner 20 would have incorporated their visual senses by witnessing the accident, their auditory senses by hearing the crash and sounds of the crowd that gathers, and their tactile/kinesthetic senses by having to move around the environment (using their keyboard arrow buttons, a mouse, or voice enabled navigation). Most important, is that each of those senses would be engaged in the single objective of having the learner make a key distinction about the concept being covered, which significantly increases the likelihood that the learner masters the concept and remembers it long-term. The memory becomes an active participant memory, instead of a passive participant memory, and being an active participant makes it easier to recall over time. As a result, each time the learner enters the environment something new can happen, or different aspect of the environment can be explored. Since the role of online instructional media in education is to provide a tool, which educators 30 can use to stimulate interaction and the involvement of learners in the learning process, using a tool that can integrate multiple senses, is a step in the right direction.

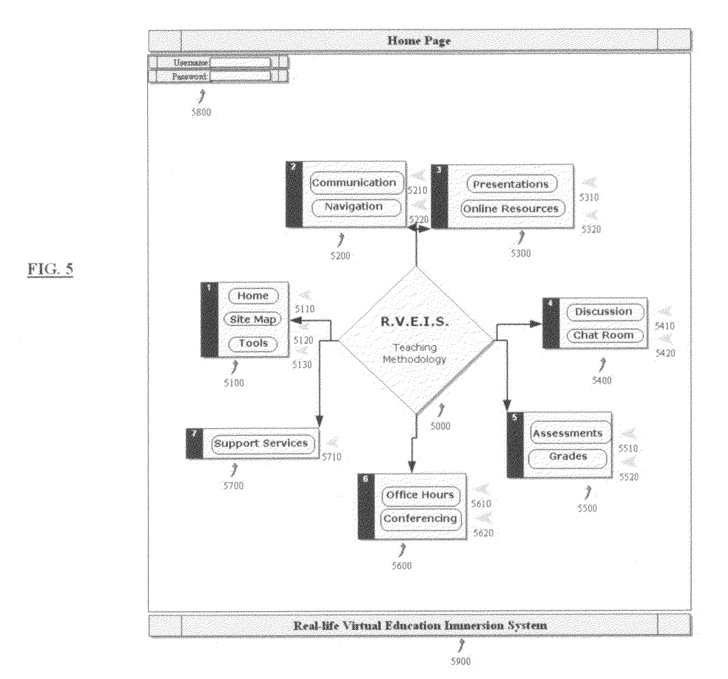

In FIG. 5, the preferred layout of an R.V.E.I.S. home page is illustrated with the area for the computer user to the answer their user name and password provided in the upper left-hand corner 5800. The home page renders as a diagram corresponding to the seven factors that correspond to the method presented in FIG. 3. Within each of the numbered boxes one through seven, there is at least one navigation button comprising an active hyperlink that takes the computer user to that designated area of the website. For example, if the computer user clicks the “Discussion” navigation button 5410 in box labeled “4” 5400, the computer user is taken to the area of the website that contains the virtual reality discussion forum. The uppermost box at the top of the screen identifies which page the computer user is currently viewing (e.g. home page), and the footer 5900 of each page contains the name of the method and system—“Real-life Virtual Education Immersion System”.

The respective navigation buttons consist a home page hyperlink (the “Home” navigation button 5110 in the box labeled “1” 5100)—which directs the user to the page represented in FIG. 5, comprising the login page, the Real-life Virtual Reality System icon 5000 with active hyperlinks that connect to each of the course content hyperlinks that comprise the Real-life Virtual Reality System 5000, a site map hyperlink (the “Site Map” navigation button 5120 in the box labeled “1” 5100)—which provides a web page comprising an itemized narrative list of each page currently available to the user on the server, a course tools hyperlink (the “Tools” navigation button 5130 in the box labeled “1” 5100)—which provides a web page comprising user account editing tools and other tools that enable a user to create their own, separate course content account that is independent of other course content accounts that can be used to exchange information with the educator users via the uploading and downloading of content chosen by the user, a communications hyperlink (the “Communication” navigation button 5210 in the box labeled “2” 5200)—which provides a web page comprising of various means to communicate with other users on the course server via voice, text, or image transmission, a navigation hyperlink (the “Navigation” navigation button 5220 in the box labeled “2” 5200)—which provides a web page comprising a selection of choices which provide various means to navigate the website via voice commands, keyboard entry, or other motion controller devices (e.g. joystick), with text, audio and video tutorials, and practice exercises to become familiar with navigating the website, for each of the respective navigation means, a multimedia presentations hyperlink (the “Presentations” navigation button 5310 in the box labeled “3” 5300)—which provides a web page comprising access to lecture slide presentations and video simulations selected and uploaded by the educator user or administrator user, an online resources hyperlink (the “Online Resources” navigation button 5320 in the box labeled “3” 5300)—which provides a web page comprising active hyperlinks to content on the Internet that is directly relevant to the course content, an interactive discussions hyperlink (the “Discussion” navigation button 5410 in the box labeled “4” 5400)—which provides access to a virtual reality environment, residing on one or more servers connected to the course content, and selected by the educator user or administrator user for the purpose of facilitating synchronous interaction amongst users of the course content, a chat room hyperlink (the “Chat Room” navigation button 5420 in the box labeled “4” 5400)—which provides a web page comprising a means for users to enter and record text synchronously or asynchronously, via voice enabled text conversion or keyboard entry, with entries becoming visible to users in the order of posting, with a corresponding timestamp and username attached to each entry, a course assessments hyperlink (the “Assessments” navigation button 5510 in the box labeled “5” 5500)—which provides a web page comprising a choice of access to task-based exercises in a virtual reality environment selected by the educator user or administrator user, downloadable files posted by an educator user or administrator user, or an active hyperlink which goes to a user created content account, where a response or user file may be uploaded and stored on the course server, visible on the Assessments webpage as an active hyperlink posted by the user, a grades hyperlink (the “Grades” navigation button 5520 in the box labeled “5” 5500)—which provides a web page comprising a table listing all graded requirements for the course, the date due, the corresponding grade if completed, a link to any feedback posted a recorded by the educator user, and for educator users and administrator users with authenticated access there is an active hyperlink to central records accounts for a learner user, or a plurality of learner users, that contains all relevant and available academic, social, financial or demographic information, an office hours hyperlink (the “Office Hours” navigation button 5610 in the box labeled “6” 5600)—which provides access to a virtual reality office wherein a learner user's avatar may interact synchronously with the educator user's avatar, or the learner user may select an available timeslot for a future synchronous interaction with the educator user's avatar, where the educator user's acceptance of the timeslot requested by the learner user will restrict access to the virtual reality office to only the educator user and the learner user making the request, unless the educator user specifically designates access to other users, a conferencing hyperlink (the “Conferencing” navigation button 5620 in the box labeled “6” 5600)—which provides a virtual reality conference room with access restricted by the educator user or administrator user, and used for facilitating synchronous interaction with a plurality of users, and a support services hyperlink (the “Support Services” navigation button 5710 in the box labeled “7” 5700)—which provides a web page comprising a means for users to contact academic or administrative support staff (registrar, counselors, administrators) via voice or text transmission for synchronous or asynchronous interaction.

It is to be understood that other embodiments of the system may utilize a different labeling system representing the 7 factors of the method provided in this invention, without departure from the scope of the invention.

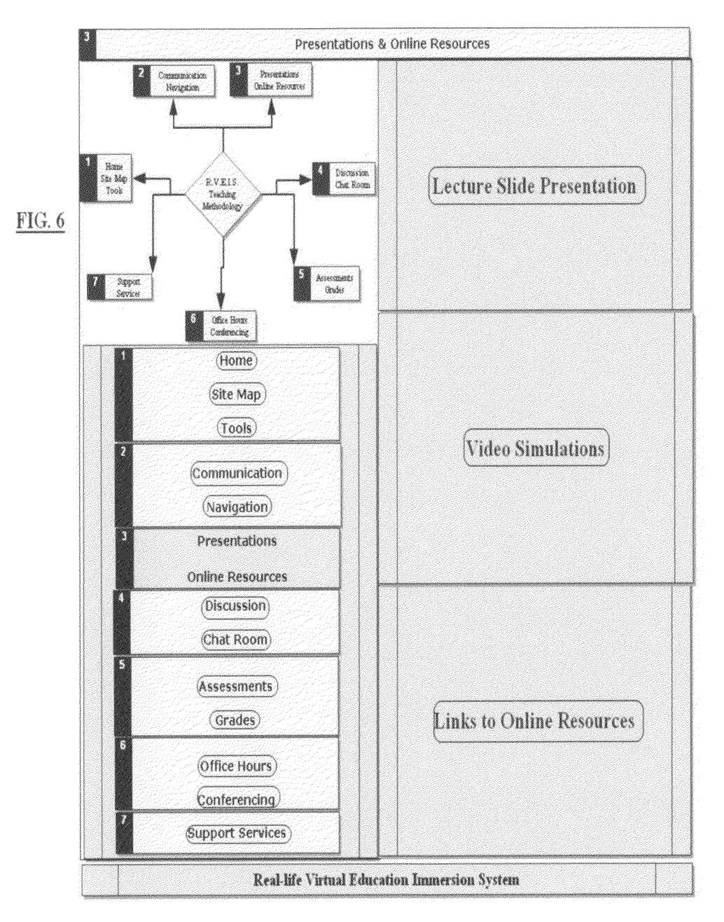

In FIG. 6, the preferred layout of a sample “Presentations & Online Resources” 5300 R.V.E.I.S. user interface page is illustrated. The left margin of the page contains the same numbered boxes that appear on the home page, but instead of rendering as a diagram, the boxes are vertically stacked in the numerical order from the footer at the bottom of the page. The current page displayed is indicated in the left margin by the box without navigation buttons and the background is the same as the rest of the page. The R.V.E.I.S. 5000 logo—which is the diagram illustrated on the homepage—appears just above box number one. The logo is a picture file, e.g. jpeg file that does not have active links or navigation buttons. The three vertically stacked large panels to the right of the seven numbered boxes in the left margin correspond to the three resources noted in item number 3 of the method, which are lecture slide presentations, video simulations, and links to online resources. Clicking the navigation button in any of the three panels takes the computer user directly to designated resources. It is to be understood that other embodiments of the system may utilize a different margins or page layout for user interface pages representing the seven factors of the method provided in this invention, without departure from the scope of the invention.

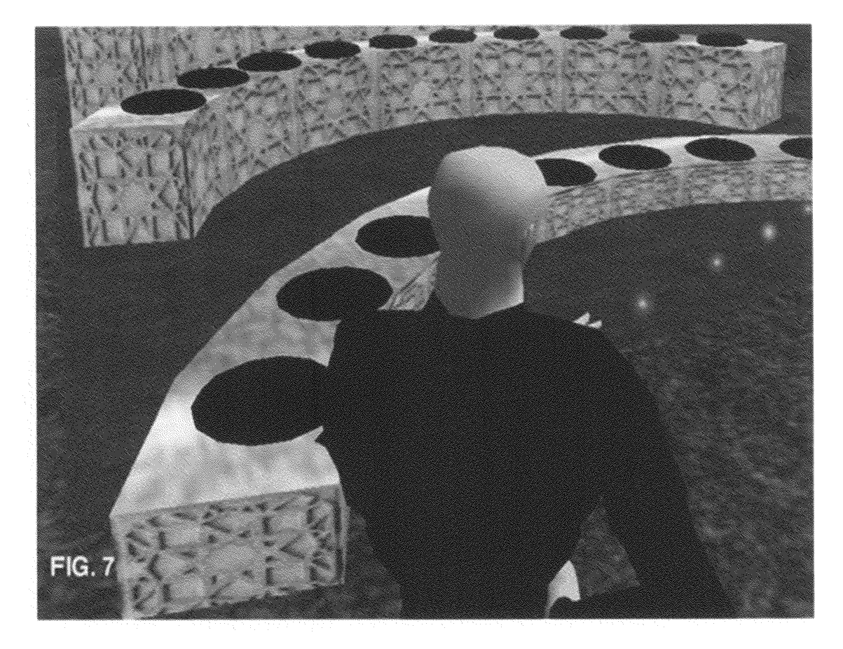

In FIG. 7, the computer user 60 has created a virtual reality graphical representation of themselves, called an “avatar”. The avatar is the human male figure in the center of the environment, and the view angle is “over the shoulder from a third person perspective”, meaning that the computer user 60 can view the environment as if they are just behind and above their avatar. The environment can also be viewed from any of 360° angles around the avatar, and this is the preferred method of viewing it the computer user 60 wants to view how their avatar is interacting with its immediate environment. For example, another computer user 60 approaching from the side will be detected more quickly from the wider view, third person perspective, than from a first person perspective. In a first person perspective, the illustrated environment would be a slightly narrower view, and the avatar would not be visible, e.g. as if you stepped directly into the avatar's shoes. For kinesthetic learners, the first person perspective may be preferred, as it provides the sense of actually being the avatar and moving through the environment from a view angle that would be from the avatar's eyes and perspective.

In this figure, the avatar's left-hand is pointing to the black semicircle at the far right edge of the screen in order to make a selection. The selection is illustrated by the linear path of the four small, white dots that extend directly from the avatar's hand to the black semicircle. For example, if the assessment were to choose the only semicircle in the viewable environment, the avatar's selection of the semicircle would be correct, and points awarded accordingly. The object selected could also be another avatar, words, shapes, symbols, photographs, or any graphical representation of an item that can be viewed through a standard Web browser. Computer user 60 selections—correct and incorrect—are stored in the R.V.E.I.S. database 8 and if the learner repeats the assessment, an alternative object or item is used for the assessment that is different from the semicircle. By recognizing and adapting to the input of a computer user 60, R.V.E.I.S. 5000 generates more effective assessments as computer user 60 proficiency increases. It is to be understood that other embodiments of the system may utilize a different virtual reality environment, with different avatar creation tools, without departure from the scope of the invention.

What is claimed is:

1. A method and system for using virtual reality software to facilitate interaction between online participants in an education community, comprising: a) a method for educators to communicate with learners via an artificial intelligence engine using an input/output arrangement, provide an assessment of learner performance and feedback to learners, facilitate learner interaction through task-based exercises to increase learner attentiveness and retention of educational content, increase learner satisfaction with the educational process and increasing enrollment retention numbers through the active engagement of the learner in the education process, and b) a system including software executable by a computer server system that provides authenticated access to a single user or a plurality of users in accordance with access levels corresponding to predetermined roles in the system by establishing a link between user accounts, central records content accounts, and course content accounts on server computers with user computers over a network, synchronizing learner user accounts with central records accounts and course content accounts, providing the means for the storing and tracking academic, social, demographic, and financial data, communicating learner status and achievement to learners, educators, administrators, academic support staff, and other parties interested in a learner's status and progress, integrating voice-enabled virtual reality interaction and speech recognition capabilities, integrating translation of a plurality of languages via software executable on the server system, adapting and modifying assessments to enhance learner mastery of concepts covered in previous assessments via software executable on the server system, automatically transmitting a learner user's grades to a central records account, generating statistical data and reports via software executable on the server system that identifies patterns of missed content items from a learner user's assessment submissions based upon educator provided rubrics, generating educationally-appropriate random variables, or presentation sequence of images, in assessments to be completed by learner users via software executable on the server system such that for non-collaborative assessments, each learner receives an assessment with at least one aspect different from other learner users in the course received, and providing a means to administer financial records of users, including enrollment and tuition payment processing, academic and development budgeting, and tracking of fundraising initiatives.

2. The system of claim 1 wherein:
the educator user or administrator user is provided with an access level to enable the creation, editing, and synchronization of a plurality of files and accounts associated with a course;
the learner user is provided with authenticated non-educator and non-administrator access to view and interact with course content accounts in the virtual reality environment, and is provided the ability to create and edit a separate content account that does not interact with other content accounts;
parents or other interested parties are provided authenticated access in order to monitor a learner's activity while logged on to the server, either synchronously or asynchronously, with user access equivalent to the learner user, access to the conferencing features of the system, and access to completion status or grades received on any graded requirement, or plurality of requirements; and
a user is required to enter an access code via an input/output arrangement on a user computer in order to be provided with access to user accounts and content accounts associated with that user's authentication code.

3. The system of claim 2 wherein the user is provided with access to a web page containing a plurality of course content hyperlinks that comprise the Real-life Virtual Reality System, wherein said content hyperlinks consist a home page hyperlink, a site map hyperlink, a tools hyperlink, a communication hyperlink, a navigation hyperlink, a presentations hyperlink, an online resources hyperlink, a discussion hyperlink, a chat room hyperlink, an assessments hyperlink, a grades hyperlink, an office hours hyperlink, a conferencing hyperlink, and a support services hyperlink.

4. The system of claim 3 wherein selection of:
the home page hyperlink provides a web page comprising a login page and course content hyperlinks that comprise the Real-life Virtual Reality System;
the site map hyperlink provides a web page comprising an itemized narrative list of each page currently available to the user on the server;
the tools hyperlink provides a web page comprising user account editing tools and other tools that enable a user to create a, separate course content account that is independent of other course content accounts, that can be used to exchange information with the educator user via the uploading and downloading of content chosen by the user;
the communication hyperlink provides a web page comprising various means to communicate with other users on the course server via voice, text, or image transmission;
the navigation hyperlink provides a web page comprising various means to navigate the website via voice commands, keyboard entry, or motion controller devices, with corresponding text, audio, video tutorials, and practice exercises to become familiar with navigating the website;
the presentations hyperlink provides a web page comprising access to slide presentations, video simulations, audio lectures, and the like, that are selected and uploaded by the educator user or administrator user;
the online resources hyperlink provides a web page comprising active hyperlinks to content on the Internet that is directly relevant to the course content;
the discussion hyperlink provides access to a virtual reality environment residing on one or more servers connected to the course content, and selected by the educator user or administrator user for the purpose of facilitating synchronous interaction amongst users of the course content;
the chat room hyperlink provides a web page comprising a means for users to enter and record text synchronously or asynchronously, via voice enabled text conversion or keyboard entry, with entries becoming visible to users in the order of posting, with a corresponding timestamp and username attached to each entry;
the assessments hyperlink provides a web page comprising a choice of access to task-based exercises in a virtual reality environment selected by the educator user or administrator user, downloadable files posted by an educator user or administrator user, or an active hyperlink which goes to a user created content account, where a response or user file may be uploaded and stored on the course server, visible on the Assessments webpage as an active hyperlink posted by the user;
the grades hyperlink provides a web page comprising a table listing all graded requirements for the course, the date graded requirements are due, the corresponding grade of assessments if completed, a link to any feedback posted a recorded by the educator user, and for educator users and administrator users with authenticated access, there is an active hyperlink to central records accounts for a learner, or a plurality of learners, that contains all relevant and available academic, social, financial or demographic information;
the office hours hyperlink provides access to a virtual reality office wherein a learner's avatar may interact synchronously with the educator's avatar, or the learner may select an available timeslot for a future synchronous interaction with the educator's avatar, where the educator's acceptance of the timeslot requested by the learner will restrict access to the virtual reality office to only the educator and the learner making the request, unless the educator specifically designates access to other users;
the conferencing hyperlink provides a virtual reality conference room used for facilitating synchronous interaction with a plurality of users, with access restricted by the educator user or administrator user; and
the support services hyperlink provides a web page comprising a means for users to contact academic or administrative support staff via voice or text transmission for synchronous or asynchronous interaction.

5. The system of claim 1 wherein one or more servers store:
learner user accounts, educator user accounts, administrator user accounts, and other interested party user accounts, created by the educator user or administrator user;
the virtual reality environment, the content comprising structural elements that comprise the course;
learner independent task-based course content accounts that are not specific to a learner user comprising assessments, weekly agenda, notices;
learner-specific course content accounts comprising grades, discussion logs, progress reports, feedback, and other data collected on the learner user while the learner user had access to the course content accounts;
central records content accounts that comprise the academic records, personality profiles, financial and demographic data, and any other collected information regarding each learner before, during, or resulting from their access to the course content accounts;
content accounts uploaded into the virtual reality environment by the educator user or administrator user; and
executable software to be executed on demand via the input/output arrangement that accesses a server, causing features of user accounts and content accounts to display on a computer accessing the server.

6. The method of claim 5, comprising executable software that causes on demand:
establishment of a content account, and synchronization with another content account, if authorized by the educator user or administrator user;
establishment of shared access between user accounts by the educator user or administrator user in virtual reality environment;
access to a virtual reality environment stored on one or more servers, if authorized by the educator user or administrator user;
matching of missed items from a learner's assessment to corresponding grading rubric guidelines that facilitate identification of suggested areas of review for the learner;
generation of random variables, or sequence of presentation changes, for task-based exercises;
generation of statistical and analytical reports based upon past and present data in a user account or content account, or plurality of user accounts or content accounts, if authorized by the educator user or administrator user; and
scheduling of reminders for course requirement deadlines or milestones for achievement.

7. The method of claim 1, comprising the educator user or administrative user:
facilitating navigation in the virtual reality environment by providing tutorials and guidance to help users understand multiple system navigation tools that allow the user's avatar to interact with the environment, providing multiple means through which to communicate with users in the virtual reality environment, and creating an educationally-appropriate virtual reality environment directly corresponding to the course content;
facilitating communication in the virtual reality environment by providing a non-graded chat room that is separate from graded interaction areas, incorporating text-to-speech conversion of input and output, multiple language translation, and voice recognition capabilities, and utilizing multiple communication methods to engage users;
engaging users through graphical organizers, online resources, presentations and the like, that are made accessible in a virtual reality environment by providing links to resources that expand comprehension and increase concept integration by illustrating real-world application of concepts, and using slides, the text, and audio lectures to explain core concepts;
facilitating collaboration and interaction between users regarding the subject matter of a content account, or plurality of content accounts, during a fixed interval of time monitored by the educator user or administrator user synchronously or asynchronously, by having learner users share a brief personal history covering their background and interests, engaging learners with open ended questions, and establishing rapport with the regular, active and substantive involvement in discussions, at a frequency of not less than once every 48 hours, illustrating proper application of the concepts being covered;
conducting a review, grading, and providing feedback to learners synchronously or asynchronously regarding the quality and quantity of the learner's interaction within 48 hours after the fixed interval time designated for the interaction has expired;
creating engaging assessments in the virtual reality environment that are educationally-appropriate, task-based exercises to be completed by a learner, or plurality of learners, via interaction with a course content account, or plurality of course content accounts, during a fixed interval of time in the virtual reality environment, initiated and monitored by the educator user or administrator user synchronously or asynchronously;
providing written or oral assessments to the learner, who will respond by uploading text files, audio files, video files, and the like, to the separate content container created by the learner user, in order to share information with the educator user, or complete written or oral tasks assigned by the educator;
conducting a review, grading, and providing feedback to the learner user synchronously or asynchronously, regarding the learner's completion of an uploaded assessment or task-based exercises in accordance with the learning objectives and with substantive recommendations for any task-based exercise performance improvement within 48 hours after the fixed interval time designated for the exercise has expired;
collating a plurality of grades, from a plurality of learner user accounts, and wherein the collated grades and relevant statistical analysis are made available to designated educators, administrators, academic support staff, and other parties interested in a learner's status and progress either individually, or in comparison with a defined group of learners associated with the course;
establishing a regular time that the educator will be available to meet with individual learners or a plurality of learners in a virtual reality environment;
facilitating technical, academic, and social support for learners by providing access to academic and nonacademic support services staff who can begin addressing learner concerns within 24 hours; and
consideration of distinctions between face-to-face and online instruction, audience learning styles, educationally appropriate context, and Socratic and facilitative methods.
